(19) United States
(12) Patent Application Publication
(10) Pub. No.: US 2004/0139612 A1
(43) Pub. Date: Jul. 22, 2004

(54) Shaving implement having a comfort strip with preventive

(75) Inventor: Rooma Mehta, Guilford, CT (US)

Correspondence Address: Richard R. Michaud, McCormic, Paulding & Huber LLP, CityPlace II, 185 Asylum Street, Hartford, CT, 06103, US

(73) Assignee: Eveready Battery Company, Inc., Westlake, OH

(21) Appl. No.: 10/733,986

(22) Filed: Dec. 11, 2003

Related U.S. Application Data
(60) Provisional application No. 60/433,400, filed on Dec. 13, 2002.

(51) Int. Cl. B26B 19/44

(52) U.S. Cl. 30/41

(57) ABSTRACT

In a shaving implement including a shaving head having a cap portion, a shaving composite having a preventive incorporated therein is mounted to the shaving implement. During shaving, at least a portion of the preventive is transferred from the shaving composite to the skin. Preferably, preventive is a photoprotective agent for protecting the skin from ultraviolet radiation.

### CROSS-REFERENCE TO RELATED APPLICATIONS

This application is entitled to the benefit of and incorporates by reference essential subject matter disclosed in Provisional Patent Application No. 60/433,400 filed on Dec. 13, 2002.

### FIELD OF THE INVENTION

The present invention is generally related to shaving equipment and is more specifically related to a shaving implement such as a razor or razor cartridge with a shaving composite having a preventive incorporated thereupon.

### BACKGROUND OF THE INVENTION

It is well known that exposure to ultraviolet radiation, such as occurs in sunlight, can cause damage to a person's skin. One such damaging effect is sunburn caused from overexposure. Overexposure to sunlight is a risk factor for the development of skin cancer, which in the case of melanomas can in some cases be fatal. Other damaging effects include premature aging of the skin, the development of pre-cancerous growths, and the development of non-melanoma skin cancers, such as basal cell or squamous cell skin cancers.

Preventives have been developed in an attempt to avoid the damaging effects caused by ultraviolet radiation. A preventive unlike a medicine attempts to ward off a condition instead of treating an existing condition. Accordingly, as used herein, the term “preventive” will be ascribed such meaning. Preventives for protecting from ultraviolet radiation, which are more commonly known by such general terms as suntan lotions and sun screens, are available in multiple forms such as lotions, gels, and creams.

Generally, preventives are rather messy to apply and are usually only used when excessive exposure to the sun is expected, such as, for example at the beach on a summer day. In these instances, one need not worry about getting preventive, e.g. suntan lotion, all over their clothing or hands. On the other hand, during the course of a normal workweek, one does need to be concerned about detrimentally affecting their appearance and the sloppy nature of preventive application is not an option. However, these people are often still exposed to large amounts of ultraviolet radiation. Accordingly, there is a current need for a mechanism for providing ultraviolet protection on a regular basis without the above-described inconveniences.

Based on the foregoing, it is the general object of the present invention to provide an apparatus for applying preventive that overcomes the problems and drawbacks and problems associated with the prior art.

### SUMMARY OF THE INVENTION

The present invention resides in one aspect in a shaving implement having a shaving head that includes a cap portion. At least one blade is coupled to the shaving head and defines a cutting edge that extends longitudinally of the cap portion and is approximately parallel thereto. A shaving composite is coupled to the cap portion and defines an outwardly facing skin engaging surface. The shaving composite includes a preventive, at least a portion of which is transferable to the user's skin during a shaving operation.

Preferably, the shaving composite is in the form of a comfort strip, which topically applies preventive to the skin surface being shaved. The outwardly facing surface of the comfort strip includes a water soluble phase with the preventive incorporated therein or thereon. In this embodiment, the comfort strip is affixed to a wet shave razor that allows for direct delivery of the preventive to the skin during a wet shave process. In the preferred embodiment of the present invention, the comfort strip includes a photoprotective agent that is at least partially transferred to a user's skin during a shaving operation. The photoprotective agent can be one constituent of a number of constitutes used in the comfort strip. For example, lubricants, lotions, or the like can be combined with the photoprotective agent.

The shaving implement can be in the form of a disposable razor cartridge or a disposable razor that includes a cartridge and handle coupled together in combination. In the razor cartridge, the blade has the cutting edge aligned with the surface of the comfort strip such that the cutting edge and the comfort strip are in simultaneous contact with the skin in the standard operational position of the razor cartridge. This permits the photoprotective agent to be applied during shaving.

### BRIEF DESCRIPTION OF THE DRAWINGS

FIG. 1 is a perspective view of a razor cartridge of the present invention.

FIG. 2 is a sectional view taken along line 2-2 of FIG. 1.

### DETAILED DESCRIPTION OF THE PREFERRED EMBODIMENTS

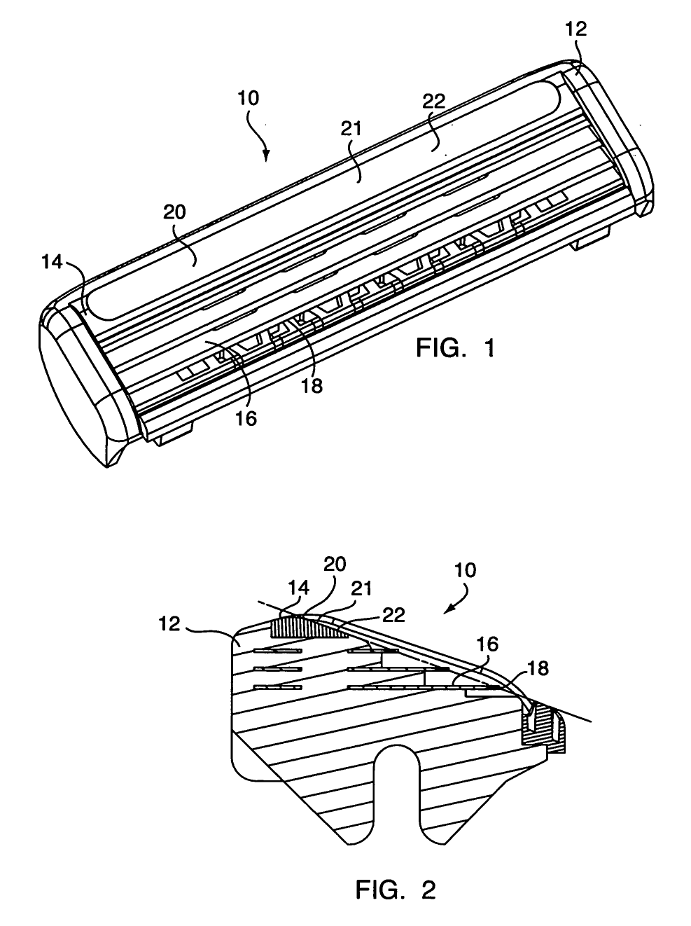

As shown in FIG. 1, the shaving implement, generally referred to by reference number 10, is in the form of a disposable razor cartridge that includes a shaving head 12 having a cap portion 14. A blade 16 is mounted to the shaving head and defines a cutting edge 18 extending longitudinally thereof approximately parallel to the cap portion. A comfort strip 20 is positioned on the cap portion 14 with a preventive 21, in the preferred embodiment a photoprotective agent, deposited thereon.

As shown in FIG. 2, the comfort strip 20 has an outwardly facing surface 22 that is aligned with the cutting edge 18 such that the razor cartridge 10 has a normal operational orientation with the skin (not shown) such that the cutting edge 18 cuts hair off skin simultaneously with the outwardly facing surface 22 gliding over the skin. However, the present invention is not limited in this regard as the can be positioned in any desired location.

In the preferred embodiment of the present invention, the comfort strip 20 is affixed to a razor cartridge 10 used with a wet shave razor. The term wet shave refers to razors that are commonly used with shaving cream and water. The comfort strip 20 typically includes a water soluble material in a carrier layer, such as, but not limited to polyethylene oxide, forming the outwardly facing surface 22. The carrier layer is supported by a water insoluble phase, such as polystyrene, polypropylene, or other suitable polymers. However, the invention should not be considered limited to a carrier layer on a water insoluble layer as the water soluble material could be positioned within the water insoluble phase. The materials that comprise the comfort strip 20 are preferably chosen such that the comfort strip 20 may be formed from a suitable plastic forming process, such as extrusion, or molding.

Since the carrier layer includes ingredients that are dissolved from the comfort strip 20 during exposure to wet shaving conditions, these ingredients including the preventive 21 will be deposited onto the user's skin. Accordingly, the above-described preventive, which in the preferred embodiment of the present invention is a photoprotective agent for reducing exposure of the skin to which it is applied to ultraviolet radiation.

Although the present invention has been described in considerable detail with reference to certain preferred versions thereof, other versions are possible. In particular, only one blade and one comfort strip have been shown, but pluralities of one, the other or both are considered within the spirit and scope of the invention. Therefore, the spirit and scope of the appended claims should not be limited to the description of the preferred versions contained herein.

What is claimed is:

1. A shaving implement comprising:
a shaving head including a cap portion;
at least one blade coupled to the shaving head and defining a cutting edge extending longitudinally of and approximately parallel to said cap portion;
a shaving composite coupled to the cap portion and defining a skin engaging surface, the shaving composite including a preventive; and wherein
at least a portion of said preventive is transferable to a user's skin upon contact therewith during a shaving operation.

2. The shaving implement of claim 1 where the cutting edge and surface are approximately aligned.

3. The shaving implement of claim 1 wherein the preventive is water-soluble.

4. The shaving implement of claim 3 wherein the preventive is a photoprotective agent.

5. The shaving implement of claim 1 wherein the preventive is a photoprotective agent.

6. A method of incorporating a preventive on a shaving implement having a shaving composite, the method comprising the steps of:
incorporating into the shaving composite a water-soluble preventive.

7. The method of claim 6 wherein the preventive is a photoprotective agent.

8. The method of claim 6 wherein the step of incorporating a preventive is accomplished by depositing the preventive onto the onto the shaving composite.

9. The method of claim 6 wherein the step of incorporating a preventive is accomplished by positioning the preventive within the shaving composite.

10. The method of claim 6 wherein before the step of incorporating a preventive, the method includes the further step of providing a shaving implement comprising a shaving head including a cap portion; at least one blade coupled to the shaving head and defining a cutting edge extending longitudinally of and approximately parallel to said cap portion; and a shaving composite coupled to the cap portion and defining a skin engaging surface.
